(19) United States
(12) Patent Application Publication
(10) Pub. No.: US 2010/0223946 A1
(43) Pub. Date: Sep. 9, 2010

(54) DEVICE FOR THE DOSAGE OF ICE CUBES

(75) Inventors: Sandra aus der Fuenten, Bielefeld (DE); Gerald Aengenheyster, Minden (DE); Nils Krutemeyer, Kirchlengern (DE)

Correspondence Address: VENABLE LLP, P.O. BOX 34385, WASHINGTON, DC, 20043-9998, US

(73) Assignee: Melitta Haushaltsprodukte GmbH & Co., KG, Minden (DE)

(21) Appl. No.: 12/700,520

(22) Filed: Feb. 4, 2010

(30) Foreign Application Priority Data
Feb. 6, 2009 (DE) 20 2009 001 489.4

(51) Int. Cl. F25C 1/24; F25C 1/00; F25C 5/02; A47J 31/44

(52) U.S. Cl. 62/320; 62/340; 62/137; 99/279

(57) ABSTRACT

An appliance for dispensing beverages includes a brewing unit through which hot water can flow for extraction, a beverage dispenser coupled to the brewing unit to dispense a prepared beverage into a container, a cooling device to supply ice for cooling a beverage, and a dosage device for ice cubes to automatically dose ice during the beverage preparation.

### CROSS-REFERENCE TO RELATED APPLICATION

This application claims the priority of German Patent Application No. DE 20 2009 001 489.4, filed on Feb. 6, 2009, the subject matter of which is incorporated herein by reference.

### BACKGROUND OF THE INVENTION

The present invention relates to an appliance for dispensing beverages, in particular coffee-based beverages, comprising a brewing unit through which hot water can flow for extraction, wherein a prepared beverage can be filled into a container at a beverage dispensing unit. The appliance further comprises a cooling device which supplies the ice for cooling a beverage.

German patent document DE 34 05 396 discloses a device for preparing a beverage by extraction, wherein a hot or cold beverage can optionally be prepared. A brewed beverage is prepared which optionally flows through a cooling container with ice. The filling of the cooling container with ice can cool down the brewed beverage. However, the dosing of the amount of ice depends on the user, and the beverage is cooled more or less, depending on the processing time, the size and the number of ice cubes. The resulting taste of the prepared beverage is therefore subject to strong fluctuations.

A device for crushing or comminuting ice cubes is known from the U.S. Pat. No. 4,176,527, by which ice cubes or crushed ice are optionally dispensed. A specific dosing can thus be used for the production of ice cubes, wherein the ice cubes are discharged directly into a container.

### SUMMARY OF THE INVENTION

It is therefore an object of the present invention to create an appliance for dispensing beverages which also allows preparing cooled drinks of high quality.

The above and other objects are accomplished according to the invention wherein there is provided, according to one embodiment, an appliance for dispensing beverages, comprising: a brewing unit through which hot water can flow for extraction; a beverage dispenser coupled to the brewing unit to dispense a prepared beverage into a container; a cooling device to supply ice for cooling a beverage; and a dosage device for ice cubes to automatically dose ice during the beverage preparation.

Therefore, according to the invention, the appliance for dispensing beverages comprises a dosage device for ice cubes in addition to the brewing unit and cooling device, wherein the dosage device permits an automatic dosing during the beverage preparation. The user is thus ensured that with the aid of a control unit, a specified beverage can be dispensed, which is cooled as desired with the aid of a predetermined amount of ice. A watering-down of the beverage resulting from too much ice or following an excessively long contact of the brewed beverage with the ice is thus avoided or, vice versa, the insufficient cooling due to an excessively short contact time is also avoided. The invention consequently makes it possible to prepare hot as well as cold beverages of high quality.

According to an embodiment of the invention, the dosage device comprises a replaceable receptacle for holding a plurality of ice cubes. The user can thus place the receptacle with the ice cubes into a freezer compartment and, when preparing a cooled beverage, can insert the receptacle with the ice cubes into the appliance, wherein this requires only a few steps. As a result, an involved cooling and the production of ice cubes in the device can be omitted. The receptacle is advantageously embodied in the shape of a tray and comprises several separate chambers with respectively one ice cube arranged therein.

For a precise dosing, the dosage device can be provided with an ejector for ejecting one or more ice cubes from the receptacle, wherein the receptacle is preferably arranged rotating inside the appliance. The receptacle may be moved to a predetermined position relative to the immovably arranged ejector for the ejection of an ice cube. The ejector can be operated with the aid of a cam shaft and can comprise a lever, which can be moved against a bottom section of the receptacle, such that the ice cube is released from the receptacle as a result of deformation or an ejection force and drops down into a container for a cooling device. To ensure easy handling, the receptacle may be made of a flexible material, in particular rubber, silicon or a plastic material.

According to a different embodiment of the invention, a holding mechanism is provided in each chamber to prevent an ice cube arranged therein from falling out since the receptacle in most cases is arranged with the open side facing downward. With only a slight melting of the ice cube, it could therefore drop down unintentionally. By installing a corresponding holding mechanism in the chamber, for example in the form of strips, projections or other elements, the ice cubes are prevented from falling out of the receptacle.

According to a another embodiment of the invention, the dosage device for ice cubes also comprises a device for crushing or comminuting ice cubes. As a result, it is ensured that not only large ice cube pieces, but also crushed pieces are metered out, thereby considerably reducing the time for cooling a beverage since the crushing considerably increases the surface area of the ice cubes. The time during which the beverage remains inside the appliance can thus be reduced noticeably. The ice cubes can optionally be transported to a container where they are collected for cooling the hot, brewed beverage, or directly into a container at a beverage dispenser.

A sensor for detecting a filling of a chamber or receptacle may be provided, so that the dosage device can also process a receptacle where only some of the chambers are filled with ice cubes. As a result, the receptacle can be reinserted into the appliance even if not all ice cubes have been used.

### BRIEF DESCRIPTION OF THE DRAWINGS

These and other features and advantages of the invention will be further understood from the following detailed description of embodiments of the invention.

FIG. 1 is a schematic view of an appliance according to the invention for dispensing beverages.

FIGS. 2A and 2B are two perspective views from above of the dosage device for the appliance.

FIG. 3 is a perspective view from below of the dosage device for the appliance.

FIG. 4 is a perspective, enlarged representation of the individual components of the dosage device.

FIGS. 5A to 5C are several perspective views of the receptacle for the dosage device.

### DETAILED DESCRIPTION OF THE PREFERRED EMBODIMENTS

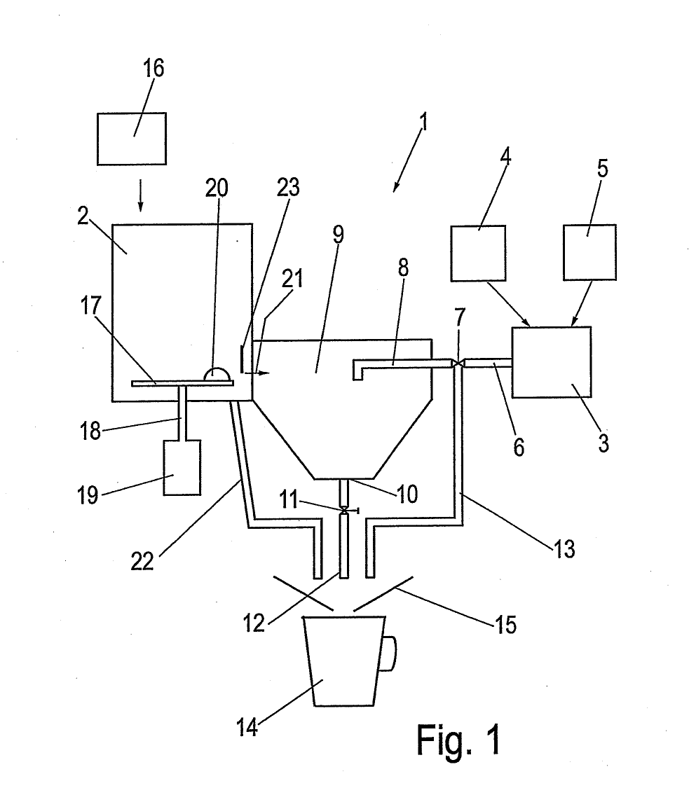

Referring initially to FIG. 1, there is shown an appliance 1 for dispensing beverages, in particular coffee. The appliance 1 comprises a device 2 for supplying ice and a brewing unit 3 for producing a hot beverage. The brewing unit 3 is supplied with the aid of a schematically shown feed-line 4 for hot water and a dosage device 5 for an extraction substance, in particular coffee. The desired amount of coffee grounds can be supplied with the aid of a grinder to the brewing unit 3. A discharge line 6 leads from the brewing unit 3 to a junction 7, which is embodied such that it can be switched to optionally conduct the brewed beverage either through a line 13 to a beverage dispenser 15 or via a feed line 8 to a collecting container 9. The lower region of the collecting container 9 is funnel-shaped and comprises a switchable valve 11 on an outlet 10 for opening or closing a discharge 12 to a beverage dispenser 15.

The beverage dispenser 15 is shown schematically as a collecting device provided with an outlet below which a container 14, especially a cup, is positioned.

A dosage device 16 is arranged above the device 2 for supplying ice and can be operated automatically to release one or a plurality of ice cubes into the device 2. The dosage device 16 in this case can be a storage container, or a collecting device for ice cubes, or a device for the production of ice cubes.

The device 2 for supplying the ice cubes comprises a container with a disc 17 arranged therein for crushing or comminuting the ice. A motor drives the disc 17 via a shaft 18, wherein a gear or clutches can optionally also be used. A projecting circulating element 20 is provided on the disc 17 by means of which ice cubes in the container are moved against a schematically shown blade 23, so that they can be comminuted or crushed and the crushed ice can be released into the collecting container 9, as shown with the arrow 21. The blade 23 may be adjustable so that the size of the crushed or comminuted ice pieces can be adjusted.

A switchable outlet can be activated if a discharge of the crushed ice into the container 14 is desired, so that the crushed ice is moved directly from the device 2 to the beverage dispenser 15, as indicated schematically with the line 22 shown herein.

For dispensing a hot beverage, the brewing unit 3 is filled with hot water and an extraction substance from the dosage device 5. Subsequently, the brewing unit dispenses the brewed beverage via the line 6 and the line 13 to the beverage dispenser 15.

Insofar as the dispensing of a cold beverage is desired, for example ice coffee or ice tea, the brewed beverage may be cooled inside the appliance 1. To accomplish this, the brewing unit 3 can be activated and at the same time and, parallel thereto, one or several ice cubes can be provided via the dosage device 16 to the device 2 for supplying the ice. In the device 2, the one or a plurality of ice cubes is then crushed and transferred to the collecting container 9. In the collecting container 9, the brewed beverage arriving from the line 8 and the crushed ice cubes from the device 2 are then collected, wherein the valve 11 can be closed for a specified interval, for example ranging from 10 to 60 seconds. During this time, the crushed ice cubes in the collecting container 9 will dissolve and can cool the brewed beverage to the desired temperature. Following this interval, the valve 11 can be opened with the aid of an adjustment element and the cooled beverage can be fed via the dispensing line 12 of the beverage dispenser 15 into the container 14. A central control (not shown) for the appliance 1 can be used to trigger the brewing unit 3, the device 2, as well as the valve 11. The device illustrated in FIG. 1 is described in more detail in co-owned U.S. application Ser. No. ______ (Atty. Docket No. 31928-284237) filed concurrently with this application, the content of which is incorporated herein by reference in its entirety.

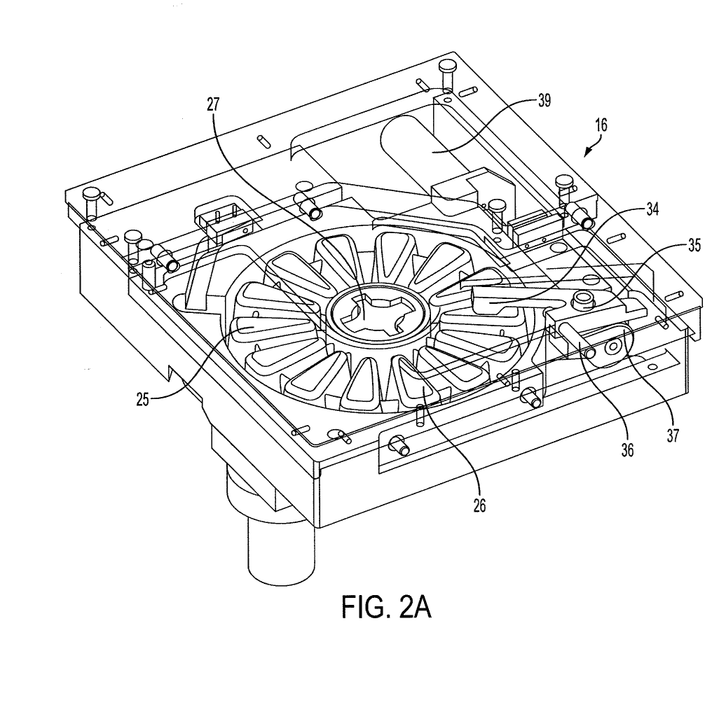

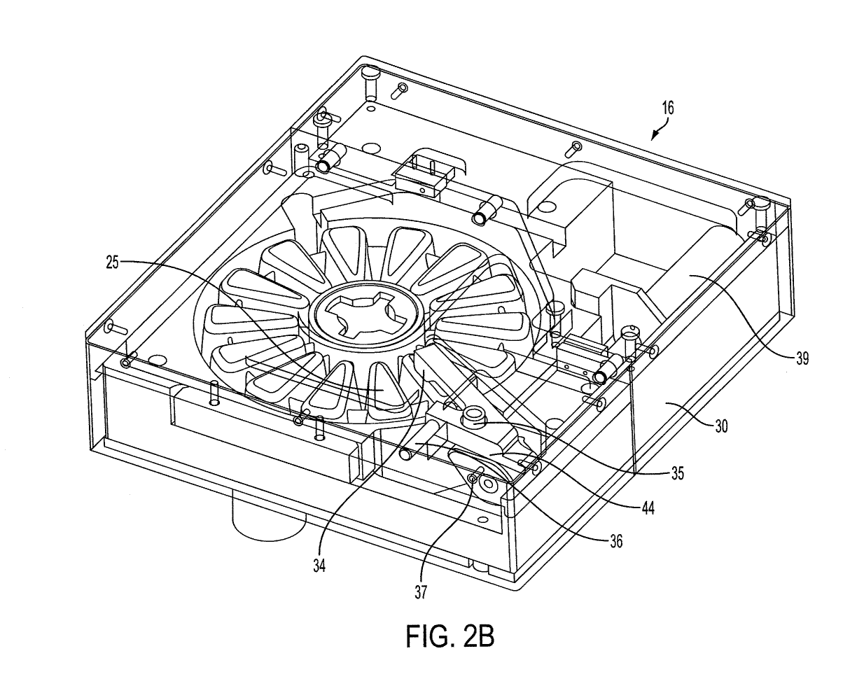

The dosage device 16 for metering out the ice cubes is illustrated in FIGS. 2A and 2B. A tray-shaped rotating receptacle 25 that comprises individual chambers 26 with respectively one ice cube positioned therein is arranged on the top of the device. The center of the receptacle 25 contains a plug-in coupling 27 which can be made to engage in a drive.

An ejector 34 in the form of a lever, which is positioned rotating around an axis 36, is provided on respectively one chamber 26 of the receptacle 25. The ejector 34 can be activated by a cam 37 on the side opposite the axis 36, wherein this cam moves the ejector 34 counter to the force of a spring 35 toward a bottom section of a chamber 26 and, in the process, pushes an ice cube out of the chamber 26.

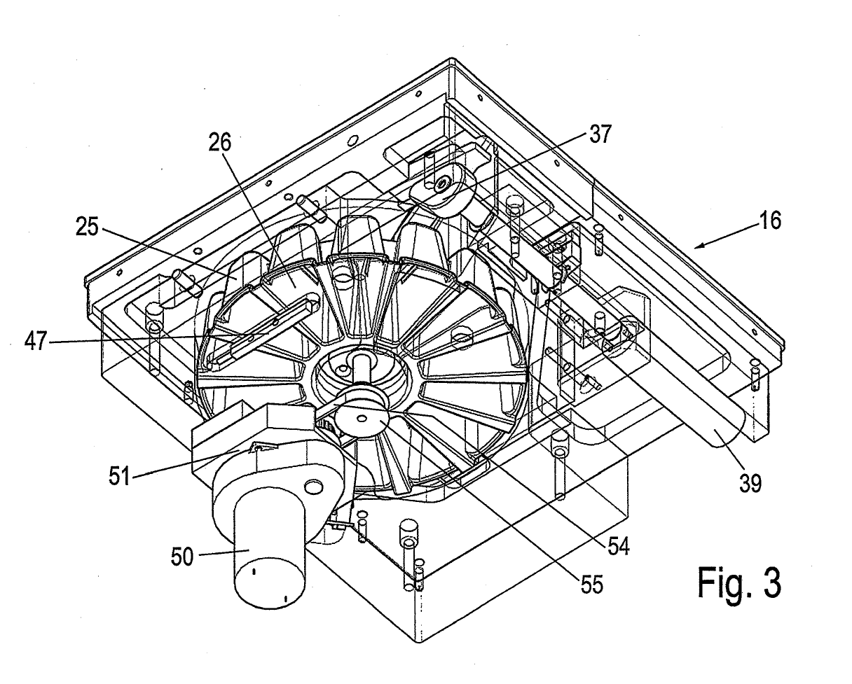

A motor 50 shown in FIG. 3 is provided for rotating the receptacle 25, so that a filled chamber 26 can arrive at the ejector 34, wherein this motor is positioned with the aid of a bearing 51 and rotates the receptacle 25 via a drive wheel 55 and a belt 54.

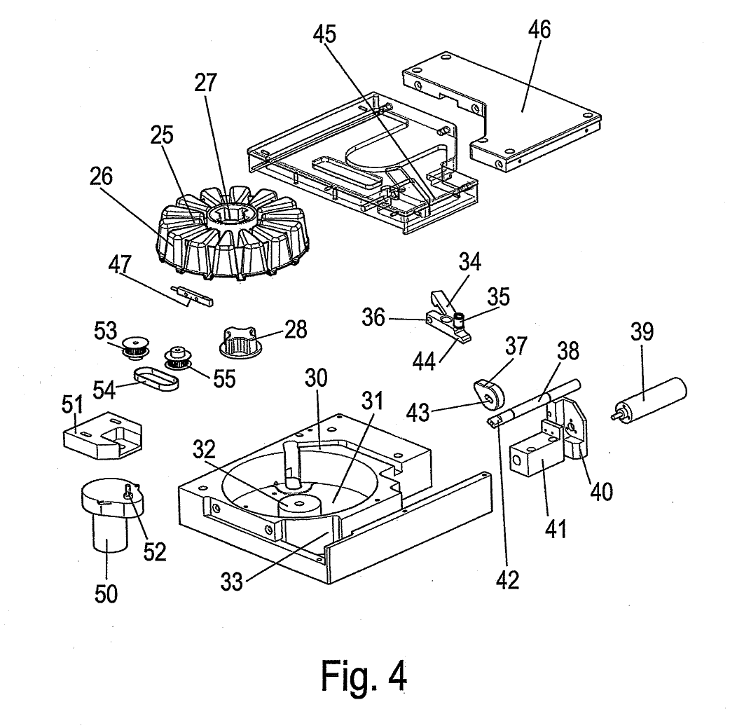

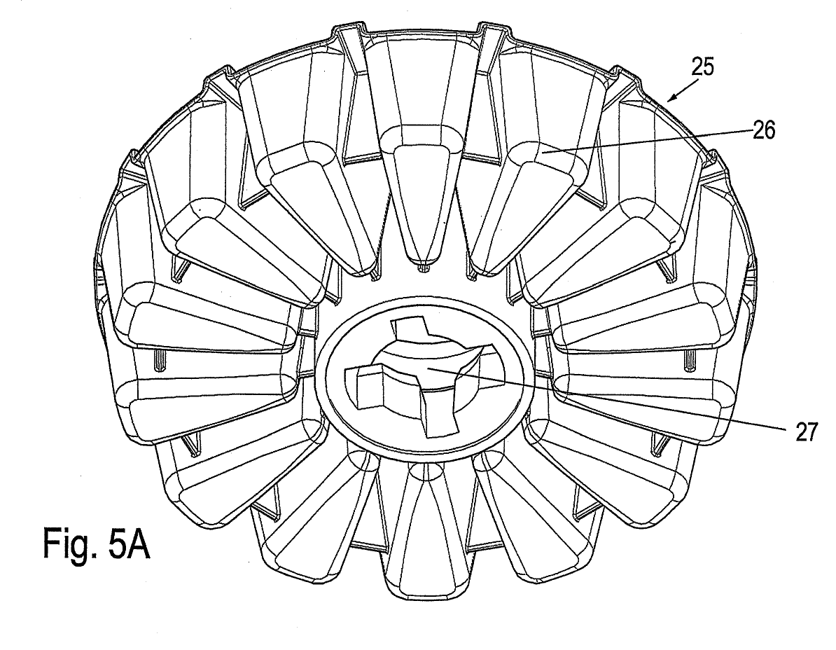

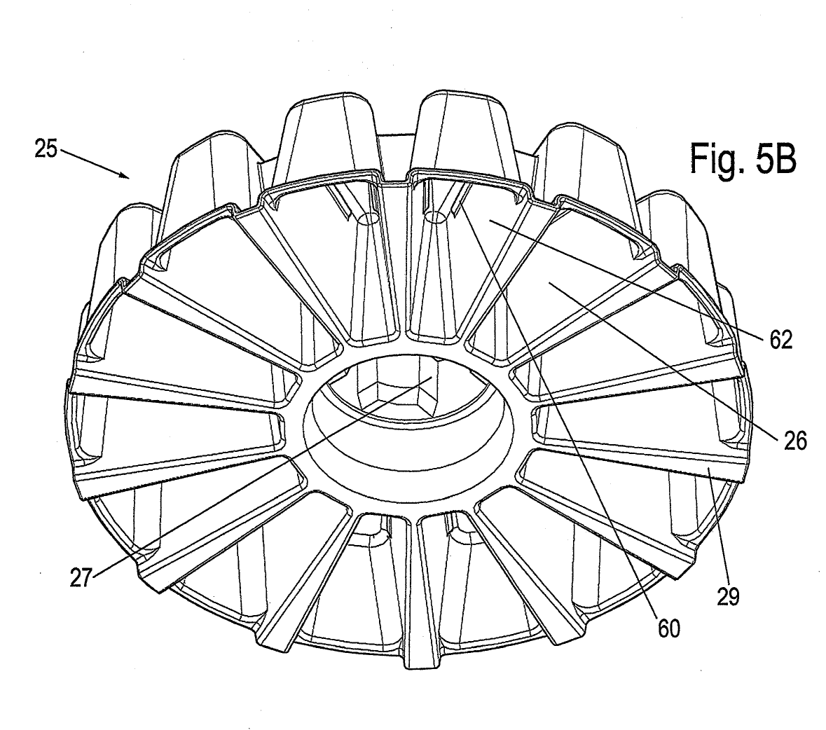

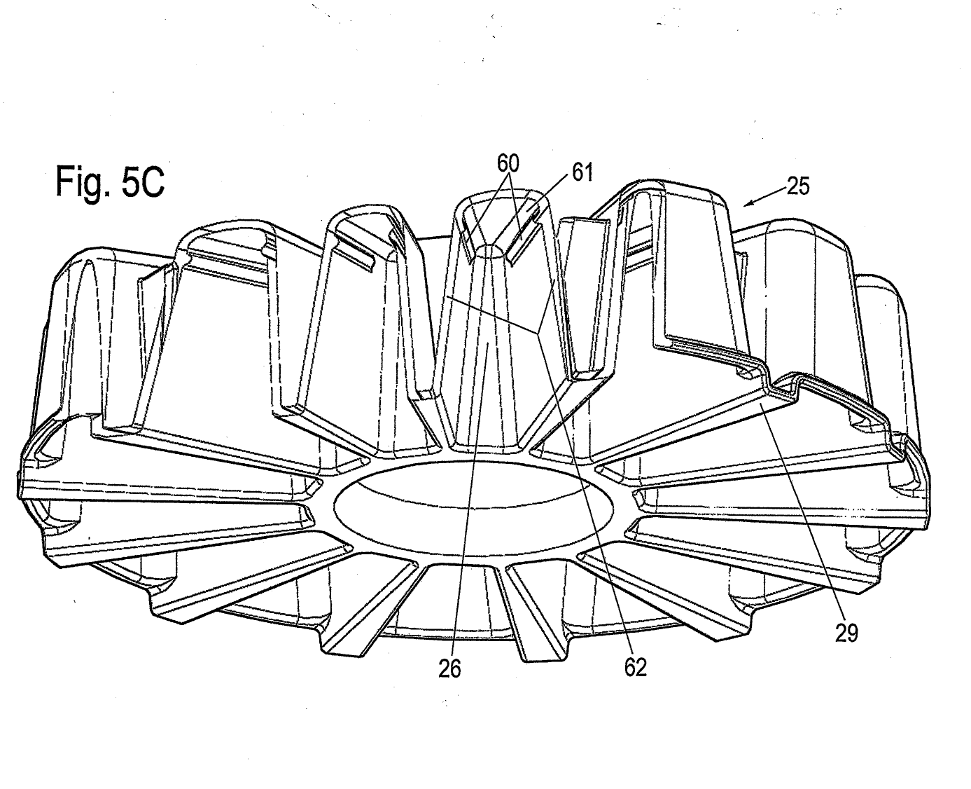

The individual components of the dosage device are shown in FIG. 4. The receptacle 25, open in a downward direction, is provided on the underside with a plurality of guide shoes 29 (see FIGS. 5B and 5C) between the individual chambers 26, which are supported on a bottom surface 31 in a recess of a housing 30. The recess furthermore contains a journal 32 in the center for positioning the receptacle 25.

The ejector 34 and the drive elements are located in a recess 33 of the housing 30, wherein the ejector 34 is rotatably positioned rotating on the housing 30 via an axis 36 (see FIGS. 2A, 2B and 4). A compression spring 35 is provided to move the ejector 34 back to the starting position, wherein a cam 37 is rigidly positioned on a shaft 38, so as to rotate along. The shaft 38 comprises a web-type end section 42 which is inserted into a corresponding slot-shaped receptacle 43 of the cam 37. The shaft 38 is driven with the aid of a motor 39 that is arranged non-rotating on the housing 30 with the aid of a bearing 40 for the motor. A bearing block 41 is furthermore provided for positioning the shaft 38.

Also arranged on the housing 30 is the motor bearing 51 for the motor 50 that rotates the receptacle 25. With the aid of a drive shaft 52, the motor 50 drives a first drive wheel 53 which in turn drives a second drive wheel 55 with the aid of a belt 54. The drive wheel 55 is coupled via a coupling 58 to the receptacle 25, so that the receptacle 25 can be rotated intermittently inside the housing 30.

A sensor 47 is provided for detecting the filling level of a chamber 26, wherein this sensor can also detect whether or not a chamber 26 contains an ice cube.

A fixed cover 46 and a movable cover 45 are furthermore provided on the housing 30.

If the user wants to obtain a cooled beverage instead of a hot beverage from the appliance 1, a request for first inserting a receptacle 25 filled with ice cubes is sent following a program selection via a display (not shown). For this, the cover 45 can be pivoted away so that the user can insert a receptacle 25 into the housing 30, wherein the receptacle 25 is either filled completely or partially with ice cubes.

With the aid of a control unit (not shown), it is then determined whether one or several ice cubes 26 are required for preparing the selected beverage. The respective number of ice cubes is released via the ejector 34 into a container of the cooling device 2 in which the ice cubes are subsequently crushed and from which they are optionally released into the storage container 9 or directly into the beverage dispenser 15.

Once all the cooled beverages have been prepared in the appliance 1, the receptacle 25 can be removed once more from the appliance 1 and deposited in the freezer compartment of a refrigerator, if applicable by filling it with water for producing further ice cubes.

In FIGS. 5A to 5C, the receptacle 25 is shown in further detail. The receptacle 25 consists of a flexible material, in particular rubber or silicon, and comprises a plurality of chambers 26, opened in a downward direction, for accommodating the ice cubes. Each chamber 26 contains a holding mechanism in the form of bars 60 that form a tapered throat section which is followed by an expanded section 61. As a result, an ice cube is held inside the chamber 26 even if a melting process has started on the walls of the ice cubes. The bars 60 form a tapered cross section which allows the ice cube to drop down only if in the expanded head section 61 the melting process has led to such a change in the geometry of the ice cube that this ice cube fits through the narrowed cross section and through the bars 60. The side walls 62 are embodied so as to be tapered outward in downward direction, which is designed to prevent undesirable holding or frictional forces from developing and to allow an easier ejection of the ice cubes.

The receptacle 25 can also take on other shapes for producing the ice cubes. In particular, it is possible to produce ice cubes having a round, square, rectangular or other geometry in place of the segment-shaped chambers. It is furthermore possible to embody the chambers 26 of the receptacle 25 with extremely low volume, so that a device for crushing or comminuting the ice cubes can be omitted.

It will be understood that the above description of the present invention is susceptible to various modifications, changes and adaptations, and the same are intended to be comprehended within the meaning and range of equivalents of the appended claims.

What is claimed is:

1. An appliance for dispensing beverages, comprising:
a brewing unit through which hot water can flow for extraction;
a beverage dispenser coupled to the brewing unit to dispense a prepared beverage into a container;
a cooling device to supply ice for cooling a beverage; and
a dosage device for ice cubes to automatically dose ice during the beverage preparation.

2. The appliance according to claim 1, wherein the dosage device comprises a replaceable receptacle that holds a plurality of ice cubes.

3. The appliance according to claim 2, wherein the receptacle has a shape of a tray and includes a plurality of separate chambers to hold respectively one ice cube.

4. The appliance according to claim 2, wherein the dosage device comprises an ejector to eject one or more ice cubes from the receptacle.

5. The appliance according to claim 4, wherein the receptacle is rotatably arranged inside the dosage device and is moveable to a predetermined position relative to the ejector for ejecting an ice cube.

6. The appliance according to claim 4, wherein the ejector comprises a lever; the dosage device further comprising a cam shaft to drive the ejector for movement toward a bottom section of the receptacle.

7. The appliance according to claim 1, wherein the receptacle is composed of a flexible material.

8. The appliance according to claim 3, wherein each chamber in the receptacle includes a holding mechanism to prevent the ice cube arranged therein from falling out.

9. The appliance according to claim 1, wherein the cooling device to supply ice comprises a device for crushing or comminuting the ice.

10. The appliance according to claim 1, further comprising a collecting container, wherein ice is transported to the collecting container for cooling the hot brewed beverage.

11. The appliance according to claim 1, further including a feed line to transport the ice from the cooling device directly to the beverage dispenser for cooling the hot brewed beverage.

12. The appliance according to claim 3, further comprising a sensor to detect the filling level of the chambers in the receptacle.
